(19) United States
(12) Patent Application Publication
(10) Pub. No.: US 2011/0099043 A1
(43) Pub. Date: Apr. 28, 2011

(54) Infrastructure System Management Based Upon Evaluated Reliability

(75) Inventors: Ratnesh Kumar Sharma, Union City, CA (US); Chih C. Shih, San Jose, CA (US); Cullen E. Bash, Los Gatos, CA (US); Amip J. Shah, Santa Clara, CA (US); Chandrakant Patel, Fremont, CA (US)

(73) Assignee: Hewlett-Packard Company

(21) Appl. No.: 12/999,615

(22) PCT Filed: Jun. 17, 2008
(86) PCT No.: PCT/US08/67213

§ 371 Date: Dec. 16, 2010

(51) Int. Cl. G06Q 10/00; G06Q 90/00

(52) U.S. Cl. 705/7.28; 705/500

(57) ABSTRACT

In a method of managing a structure having an infrastructure system, a plurality of candidate components configured to provide redundancy to the infrastructure system are identified. Reliability levels of the structure are evaluated with a plurality of different combinations of candidate components. In addition, the structure is managed based upon the evaluated reliability levels.

### CROSS-REFERENCES

The present application has the same Assignee and shares some common subject matter with U.S. Pat. No. 6,574,104, entitled “Smart Cooling of Data Centers”, issued on Jun. 3, 2003, the disclosure of which is hereby incorporated by reference in its entirety.

### BACKGROUND

Advances in technology are making it possible for servers capable of performing tasks of ever-increasing complexity at ever-increasing speeds to continually become smaller and denser. One result of this increase in performance and decrease in size is that the servers are now requiring significantly greater amounts of power and generating significantly greater amounts of heat load as compared with earlier servers. Another result is that the amount of energy required to remove the heat loads through use of a cooling infrastructure has also increased significantly. In addition, the level of redundancy in both the power supply and cooling infrastructure has been increased to meet increasing uptime requirements. The difficulties associated with powering and cooling the servers is further exacerbated when a relatively large number of servers are arranged in one area, as is typical in information technology data centers.

Data centers are typically equipped with redundant air conditioning units and power supply components to substantially ensure a relatively high percentage uptime. One approach to adding the redundant air conditioning units has been to add one redundant air conditioning unit for every two determined to be necessary in the data center, with the placement of the redundant air conditioning unit being driven by intuition. In addition, the redundant air conditioning units are typically maintained in active conditions when the other air conditioning units are active, thereby unnecessarily consuming electricity.

It would thus be beneficial to achieve desired levels of uptime percentage while reducing costs associated with adding redundancy to the power supply and cooling infrastructures and in operating the power supply and cooling infrastructures.

### BRIEF DESCRIPTION OF THE DRAWINGS

Features of the present invention will become apparent to those skilled in the art from the following description with reference to the figures, in which:

FIG. 1 shows a simplified block diagram of a system for evaluating reliability of an infrastructure system in a structure, according to an embodiment of the invention;

FIG. 2A illustrates a flow diagram of a method of evaluating reliability of one or more infrastructure systems in a structure, according to an embodiment of the invention;

FIG. 2B illustrates a flow diagram of a method of evaluating reliability of one or more infrastructure systems in a structure, according to an embodiment of the invention;

FIGS. 3A and 3B, collectively, illustrate a flow diagram of a method of evaluating reliability of one or more infrastructure systems in a structure, according to an embodiment of the invention; and

FIG. 4 shows a block diagram of a computing apparatus configured to implement or execute the reliability evaluator depicted in FIG. 1, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a method and system for managing a structure having an infrastructure system based upon an evaluated reliability of the structure. The reliability may be evaluated, for instance, to determine one or more infrastructure system or component architectures that substantially optimize reliability of the one or more infrastructure systems or components with the purpose of substantially maximizing system level reliability (percentage uptime), while substantially minimizing redundancy. The reduction in the redundancy may also result in one or more reduced metrics, such as, costs, exergy loss, carbon footprint, personnel required, etc., associated with installation and operation of the components configured to provide the redundancy. Thus, according to an example, the infrastructure system may be managed in various manners to substantially maximize reliability while substantially minimizing redundancy.

According to another example, the reliability and the metrics associated with providing the redundancy may be evaluated to determine one or more infrastructure system or component architectures that substantially optimize reliability, metric(s), and redundancy. By way of example, one or more infrastructure system or component architectures may be determined that substantially minimizes costs associated with providing the redundancy at the expense of reliability, if this determination significantly reduces costs.

The method and system for managing an infrastructure system disclosed herein may be implemented to synthesize a structure, such as, a data center, to meet a predefined reliability goal. By way of particular example, the method and system disclosed herein may be implemented to select, design, upgrade or replace one or more infrastructure system components or systems, such as, components for use in power delivery, cooling, networking, computing, data storage, etc., of the data center. In addition, the method and system disclosed herein may be implemented to select components configured to provide redundancy to one or more the infrastructure systems. As an example, the method and system disclosed herein generally enables systems and/or components to be selected to substantially minimize costs while meeting the predefined reliability goal. As another example, the method and system disclosed herein generally enables systems and/or components to be selected to substantially optimize reliability with respect to costs.

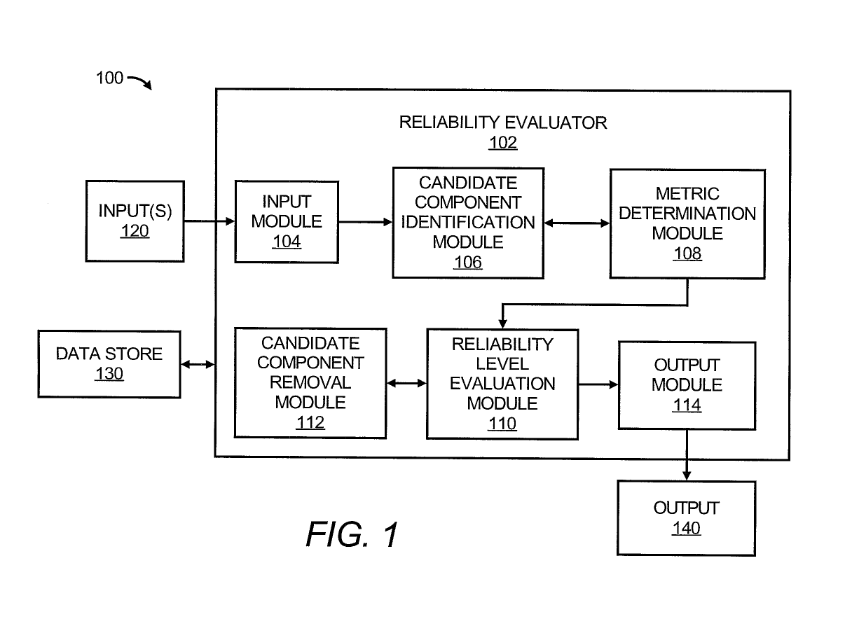

With reference first to FIG. 1, there is shown a simplified block diagram of a system 100 for managing a structure having an infrastructure system based upon evaluated reliability levels of the structure, according to an example. It should be understood that the system 100 may include additional elements and that some of the elements described herein may be removed and/or modified without departing from a scope of the system 100.

As shown, the system 100 includes a reliability evaluator 102, which may comprise software, firmware, or hardware configured to evaluate reliability of an infrastructure system in a structure. Generally speaking, the reliability evaluator 102 may be configured to evaluate features of one or more infrastructure systems to identify a substantially optimized configuration and operation of the infrastructure system(s). An infrastructure system may be considered to have a substantially optimized configuration and operation when the infrastructure system meets a predefined reliability level while substantially minimizing a metric, such as, costs (either or both of initial and operational costs), associated with providing the redundancies. In one regard, therefore, the reliability evaluator 102 is configured to identify architectures for the infrastructure system(s) that are to operate at a minimum redundancy level while also enabling a predefined level of availability or uptime percentage for the components, such as, servers, storage equipment, networking equipment, etc., in the structure to which the infrastructure system is associated. In another regard, the reliability evaluator 102 is configured to substantially maximize reliability while remaining within a desired metric budget. In a further regard, the reliability evaluator 102 may even reduce reliability if the reliability evaluator 102 determines that such a reduction in reliability results in a significantly lower metric, such as, cost.

The one or more infrastructure systems discussed herein may comprise a power supply infrastructure, cooling infrastructure, networking infrastructure, data storage infrastructure, compute infrastructure, etc. The power supply infrastructure includes power supply components, such as, inductors, converters, inverters, etc. The cooling infrastructure includes cooling components, such as, air conditioning units, compressors, chillers, blowers, etc. The networking infrastructure includes networking components, such as, switches, hubs, routers, firewalls, etc. The data storage infrastructure comprises storage components, such as, tape drives, SAN, NAS, etc. The compute infrastructure comprises compute components, such as, servers, blade servers, processors, etc. The infrastructure system(s) may be associated with any reasonably suitable type of structure including, for instance, an information technology data center, a mobile data center, one or more electronics cabinets housing a plurality of servers, etc.

The reliability evaluator 102 is depicted as including an input module 104, a candidate component identification module 106, a metric determination module 108, a reliability level evaluation module 110, a candidate removal module 112, and an output module 116. In addition, the reliability evaluator 102 is depicted as being connected to one or more inputs 120, a data store 130, and an output 140.

In instances where the reliability evaluator 102 comprises software, the reliability evaluator 102 may be stored on a computer readable storage medium and may be executed by the processor of a computing device (not shown). In these instances, the modules 104-114 may comprise software modules or other programs or algorithms configured to perform the functions described herein below. In instances where the reliability evaluator 102 comprises firmware or hardware, the reliability evaluator 102 may comprise a circuit or other apparatus configured to perform the functions described herein. In these instances, the modules 104-114 may comprise one or more of software modules and hardware modules.

As shown in FIG. 1, the input module 104 is configured to receive data from the input(s) 120. The input(s) 120 may comprise any reasonably suitable input, such as, a keyboard, mouse, external or internal data storage device, etc., through which data may be inputted into the reliability evaluator 102. The inputted data may include parameters related to the structure and to the infrastructure system that impact reliability and redundancy. By way of example, the inputted data may include, for instance, a desired reliability level of the structure, data pertaining to the components of the structure, candidate component options and data relating to the candidate components, etc.

The parameters related to the structure and the infrastructure system may include, for instance, equipment placement constraints, existing power infrastructure architectures, cooling infrastructure architectures, growth patterns and schedules, etc. The parameters may also include information pertaining to the components of the structure and the infrastructure system. This information may include, for instance, the power supply capacity of the power supply infrastructure, the cooling capacity of the cooling infrastructure, the computing capacity of the computing infrastructure, etc. The parameters may further include the minimum amount of power supply and cooling capacity required for the components, such as, servers, networking equipment, storage devices, etc., either designed for or housed in the structure.

In any regard, the reliability evaluator 102 may store the data received from the input(s) 120 in the data store 130, which may comprise volatile and/or non-volatile memory, such as DRAM, EEPROM, MRAM, flash memory, and the like. In addition, or alternatively, the data store 130 may comprise a device configured to read from and write to a removable media, such as, a floppy disk, a CD-ROM, a DVD-ROM, or other optical or magnetic media. Although the data store 130 is depicted as comprising a component separate from the reliability evaluator 102, the data store 130 may be integrated with the reliability evaluator 102 without departing from a scope of the reliability evaluator 102.

The input module 104 may also provide a graphical user interface through which a user may control the reliability evaluator 102. For instance, a user may use the graphical user interface to activate the reliability evaluator 102, to input additional information into the reliability evaluator 102, etc.

The candidate component identification module 106 is configured to identify candidate components for use in providing redundancy in one or more of the infrastructure systems. The candidate components may be identified based upon, for instance, predefined efficiencies of the components, availability of the components, lifetime criteria of the components, etc. As an example, the candidate components may comprise additional power supply components that may provide redundancy to the power supply components currently implemented in the structure. As another example, the candidate components may comprise additional cooling infrastructure components that may provide redundant cooling to the structure.

The metric determination module 108 is configured to determine one or more metrics associated with the candidate components. The metrics may include costs associated with the candidate components, which may include at least one of the initial costs associated with installing the candidate components, the operational costs associated with implementing the candidate components, the depreciation/amortization costs of the candidate components, etc. The metrics may also include exergy-loss, carbon footprint, or other metrics related to the environmental impact of the candidate components, the personnel required for the upkeep of the candidate components, component performance metrics, a combination of metrics, etc.

The reliability level evaluation module 110 is configured to evaluate the reliability levels of the candidate components. The reliability levels of the candidate components may be evaluated based upon, for instance, the loads and environmental conditions the components are designed to endure over a design lifetime. The reliability levels of the candidate components may be obtained from the component manufacturers and/or through testing of the candidate components.

The identified candidate components, the metric(s) associated with the candidate components, and the reliability levels of the candidate components may be stored in the data store 130. The candidate component removal module 112 may access the data contained in the data store 130 to determine which of the candidate components to remove from one or more of the infrastructure systems. In one example, the candidate component removal module 112 may initially attempt to select candidate components having relatively higher costs prior to selecting candidate components having relatively lower costs to remove.

In addition, the reliability level evaluation module 110 is also configured to evaluate the reliability level of the structure in response to the candidate component being removed from the one or more infrastructure systems. The results of the evaluation may be outputted to the output 140 by the output module 114. The output 140 may comprise, for instance, a display configured to display the results of the evaluation, such as, the reliability levels of the one or more infrastructure systems with different combinations of candidate components. In addition, or alternatively, the output 140 may comprise a fixed or removable storage device on which the evaluation results are stored, such as, the data store 130. As a further alternative, the output 140 may comprise a connection to a network over which the information may be communicated. As a yet further example, the output 140 may comprise information which is provided to a functional module configured to make various component control decisions. In this example, the functional module may, for instance, use the information contained in the output 140 to automatically turn off redundant components which are not necessary to meet one or more of power, cooling, reliability, etc., constraints.

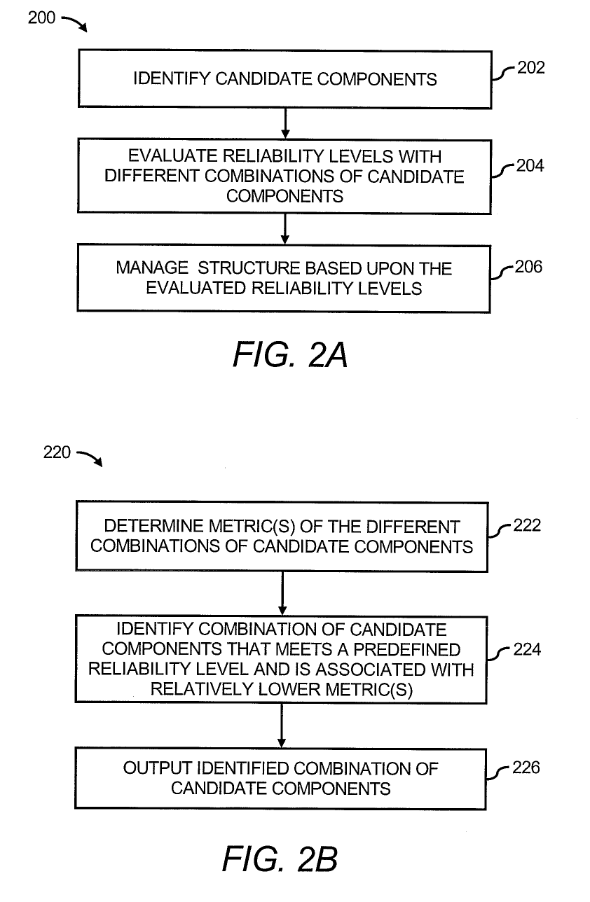

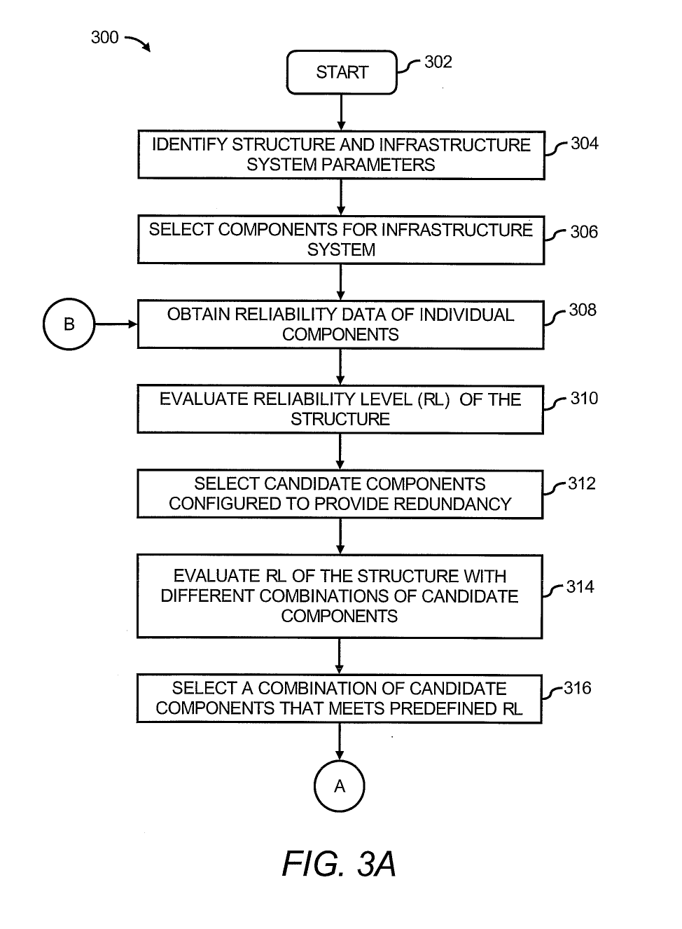

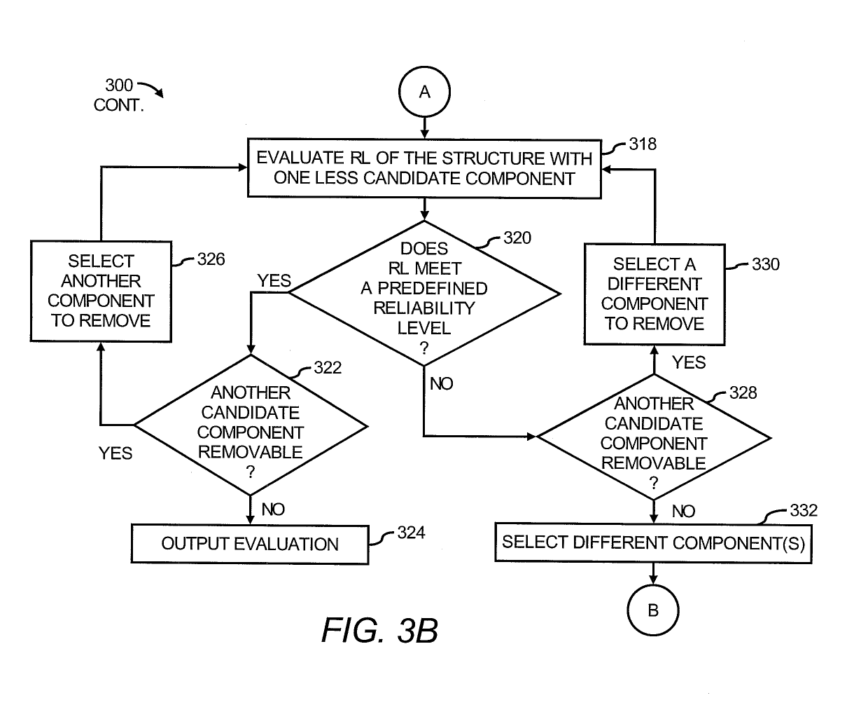

Examples of methods in which the system 100 may be employed to manage a structure based upon evaluated reliability of the structure, for instance, to identify configurations for one or more infrastructure systems that substantially minimize metric(s), such as, costs, environmental impact, etc., associated with meeting a predefined reliability requirement, will now be described with respect to the following flow diagrams of the methods 200, 220 and 300 respectively depicted in FIGS. 2A, 2B, 3A, and 3B. It should be apparent to those of ordinary skill in the art that the methods 200, 220, and 300 represent generalized illustrations and that other steps may be added or existing steps may be removed, modified or rearranged without departing from the scopes of the methods 200, 220, and 300.

The descriptions of the methods 200, 220, and 300 are made with reference to the system 100 illustrated in FIG. 1, and thus makes reference to the elements cited therein. It should, however, be understood that the methods 200, 220, and 300 are not limited to the elements set forth in the system 100. Instead, it should be understood that the methods 200, 220, and 300 may be practiced by a system having a different configuration than that set forth in the system 100.

Some or all of the operations set forth in the methods 200, 220, and 300 may be contained as utilities, programs, or subprograms, in any desired computer accessible medium. In addition, the methods 200, 220, and 300 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

A controller, such as a processor (not shown), ASIC, microcontroller, etc., may implement or execute the reliability evaluator 102 to perform either or both of the methods 200, 220, and 300 in evaluating reliability of an infrastructure system. Alternatively, the reliability evaluator 102 may be configured to operate independently of any other processor or computing device. In any regard, the methods 200, 220, and 300 may be implemented or executed to determine reliability levels associated with various combinations of candidate components. As another example, the methods 200, 220, and 300 may be implemented or executed to substantially maximize system level reliability, for instance, in terms of percentage uptime, while substantially minimizing costs associated with meeting the maximized system level reliability. Similarly, the methods 200, 220, and 300 may be implemented or executed to substantially minimize the costs associated with providing a predefined level of reliability and availability to the structure.

According to an example, the methods 200, 220, and 300 may be implemented or executed to synthesize a structure design for meeting a desired reliability goal while substantially minimizing costs associated with meeting the desired reliability goal. In another example, the methods 200, 220, and 300 may be implemented or executed to determine which components of a structure may require an upgrade to enable the structure to respond to a reliability goal change as may be required through a change in a service level agreement provision.

In any regard, with reference first to FIG. 2A, there is shown a flow diagram of a method 200 of managing a structure having one or more infrastructure systems based upon evaluated reliability levels of the structure, according to an example. At step 202, a plurality of candidate components configured to provide redundancy to one or more of the infrastructure systems are identified. The addition of the candidate components is generally designed to increase reliability and availability in the structure by providing additional redundancy to the one or more infrastructure systems.

At step 204, reliability levels of the structure with a plurality of different combinations of candidate components are evaluated. The reliability levels of the structure may be determined, for instance, through an evaluation of the reliability levels of the individual candidate components as determined by the component manufacturers and/or through testing.

At step 206, the structure is managed based upon the evaluated reliability levels. In one example, the structure may be managed by outputting the evaluated reliability levels of the structure with the different combinations of candidate components as discussed above. Although the method 200 may end following step 206, the method 200 may be continued to determine and output combinations of candidate components that substantially meet a predefined reliability level while substantially minimizing at least one metric, such as, costs, environmental impact, etc., associated with meeting the predefined reliability level.

Turning now to FIG. 2B, there is shown a flow diagram of a method 220 of managing a structure having one or more infrastructure systems based upon evaluated reliability levels of the structure, according to an example. At step 222, the metric(s) associated with the different combinations of candidate components are determined. As discussed above, the metrics may comprise costs, environmental impacts, personnel requirements, etc., associated with at least one of installing and operating the different combinations of candidate components.

At step 224, a combination of candidate components that meets a predefined reliability level and is associated with a relatively low metric is identified. As discussed above, the predefined reliability level may be based upon provisions set forth in a service level agreement. The predefined reliability level may also be based upon guidelines, for instance, as set in industry standards or by governmental agencies, etc.

At step 226, the identified combination of candidate components that meets the predefined reliability level and is associated with relatively low metric is outputted. In one example, the combination of candidate components that both meets the predefined reliability level and is associated with the lowest at least one metric is identified at step 224 and outputted at step 226. As such, the method 220 may be implemented to not only identify the reliability levels with different combinations of candidate components, but may also be implemented to identify which of the different combinations of candidate components results in the lowest metric(s) in terms of either or both of installing and operating the different combinations of candidate components.

With particular reference now to FIGS. 3A and 3B, collectively, there is shown a flow diagram of a method 300 of managing a structure based upon evaluated reliability of one or more infrastructure systems in a structure, according to another example. The method 300 is similar to the method 200 depicted in FIG. 2A, but provides a greater level of detail.

The method 300 may be initiated at step 302 in response to an instruction from a user to become initiated. In addition, or alternatively, a controller (not shown) may be programmed to initiate the reliability evaluator 102 at a predetermined time, at predetermined time intervals, in response to a predetermined condition occurring, etc.

In any regard, at step 304, one or more structure and infrastructure system parameters are identified. The parameters may include, for instance, the constraints on where equipment, such as, computing equipment, networking equipment, cooling equipment, etc., may be placed in the structure, the power delivery and cooling infrastructure architectures, the networking architecture, forecasted growth patterns and schedules, etc. Additional constraints may include, for instance, the types of processing jobs that are likely to be performed in structure, the amount of load likely to be placed on the equipment contained in the structure, etc. Additional parameters related to, for instance, the minimum power supply and cooling capacity required to meet the constraints may also be identified. In any regard, the parameters may be identified at step 304 from user inputs, from data collected and stored in the data store 130, etc.

At step 306, components for one or more infrastructure systems may be selected. The selected components may include, for instance, power supply components, cooling infrastructure components, networking infrastructure components, etc. In addition, the components may be selected based upon the structure and infrastructure system parameters accessed at step 304. Thus, for instance, power supply components that are capable of supplying sufficient levels of power to substantially meet the parameters identified at step 304 may be selected. As another example, cooling infrastructure components that are capable of supplying sufficient levels of cooling to substantially meet the heat loads anticipated to be generated by the components housed in the structure identified at step 304 may be selected. The components of the infrastructure system may also be selected based upon predefined efficiency levels, predefined availability levels, various lifetime criteria, etc.

At step 308, reliability data relating to the individual components selected at step 306 may be obtained. The reliability data may comprise the anticipated reliability of the individual components for operation at design loads and environmental conditions for a design lifetime. The reliability data may be obtained from the components manufacturer or through testing or modeling of the components to determine when the components are likely to fail under predefined conditions.

At step 310, a reliability level (RL) of the structure, including the infrastructure systems, without redundant infrastructure systems may be evaluated. The reliability level of the structure may be evaluated based upon the reliability data of the plurality of components. By way of example, the reliability level of the structure may be equivalent to the reliability level of the component having the lowest reliability level. In addition, or alternatively, the reliability level of the structure may be equivalent to an average reliability level of the components.

At step 312, candidate components configured to provide redundancy to one or more infrastructure systems are selected. The candidate components may include a range of various components that may be used to provide redundancy, such as, various types of air conditioning units, various components in air conditioning units, various power supply components, various networking equipment, etc. The candidate components may be selected, for instance, based upon cost, design reliability levels, capacity, etc.

At step 314, the reliability level of the structure may be evaluated with different combinations of candidate components. According to an example, the reliability level of the structure may be evaluated based upon individual reliability levels of the candidate components.

At step 316, a combination of candidate components that meets a predefined reliability level may be selected. As discussed above, the predefined reliability level may comprise, for instance, a minimum reliability level allowable that the structure is configured to meet. By way of example, the predefined reliability level may comprise a reliability level that is agreed upon by an operator of the structure and a client through a service level agreement.

In any regard, the selection of the combination of candidate components at step 316 may also include evaluation of the costs associated with each of the combination of candidate components. Thus, for instance, step 316 may be similar to step 210 discussed above with respect to the method 200 (FIG. 2). In addition, the selected combination of candidate components that substantially meets the requirements defined in step 310 may be outputted as indicated at step 212, and the method 300 may end. However, the method 300 may be continued to further minimize the components implemented to provide redundancy in the structure, if possible.

At step 318 (FIG. 3B), the reliability level of the structure with one less candidate component is evaluated. The selection of which candidate component to remove may be based upon, for instance, the costs associated with implementing the candidate component, the reliability level of the candidate component, the environmental impact of the candidate component, etc. Thus, for instance, a candidate component that is associated with a relatively higher metric level may be selected for removal over a candidate component that is associated with a relatively lower metric level.

At step 320, a determination as to whether the reliability level of the structure with the one less candidate component evaluated at step 318 meets the predefined reliability level is made. If the reliability level substantially meets the predefined reliability level at step 320, a determination as to whether another candidate component is removable is made, as indicated at step 322. Another candidate component may be determined as being removable if, for instance, the resulting reliability level of the infrastructure with the candidate component removed remains greater than the predefined reliability level.

If another candidate component is not available for removal, the evaluation performed at step 318 may be outputted at step 324. In other words, the reliability evaluator 102 may output the evaluation of the reliability level of the structure with one less candidate component configured to provide redundancy to the output 140.

If, however, another candidate component is available for removal, another candidate component to be removed may be selected at step 326. The selection of which candidate component to be removed may be based upon any of the factors discussed above with respect to step 318. In addition, the reliability level of the structure may again be evaluated at step 318 with the another component removed. In addition, step 320 may be performed again to determine whether the reliability level of the structure with the multiple candidate components removed substantially meets the predefined reliability level. Steps 318 to 322 may be repeated so long as the “yes” condition is met at steps 320 and 322.

If, however, a “no” condition is met at step 320, in which case the reliability level of the structure evaluated at step 318 has been determined as failing to meet the predefined reliability level, a determination as to whether another candidate component is removable is made, as indicated at step 328. This determination may be made as discussed above with respect to step 322.

If a determination that a candidate component is removable is made at step 328, the candidate component removed at step 318 is re-inserted and a different candidate component is selected for removal, as indicated at step 330. The selection of which candidate component to be removed may be based upon any of the factors discussed above with respect to step 318. In addition, the reliability level of the structure may again be evaluated at step 318 with the original candidate component re-inserted and the different component removed. In addition, step 320 may be performed again to determine whether the reliability level of the structure with the different candidate component removed substantially meets the predefined reliability level. Steps 318, 320, 328 and 330 may be repeated so long as the “no” condition is met at step 320 and a “yes” condition is met at step 328.

If, however, a “no” condition is met at step 328, one or more different components may be selected for one or more infrastructure systems, as indicated at step 332. By way of example, a cooling infrastructure component selected at step 306 may be replaced with a component associated with a relatively higher price and a higher reliability level at step 332.

Steps 308-332 may be repeated until the candidate components cannot further be minimized while still substantially meeting the predefined reliability level. As such, for instance, the method 300 may be implemented to determine infrastructure system architectures that provide desired levels of reliability while substantially reducing metrics, such as, costs, etc., associated with providing redundancy to meet the predefined reliability level.

According to another example, a structure design may be synthesized by combining zones of infrastructure systems having different reliability levels in a structure to further reduce costs associated with providing redundancy to meet predefined reliability levels. In this example, those services identified as being relatively more critical, and thus requiring greater percentage uptime, may be allocated to the zones of infrastructure systems having relatively higher reliability levels, while those services identified as being relatively less critical may be allocated to zones having relatively lesser reliability levels.

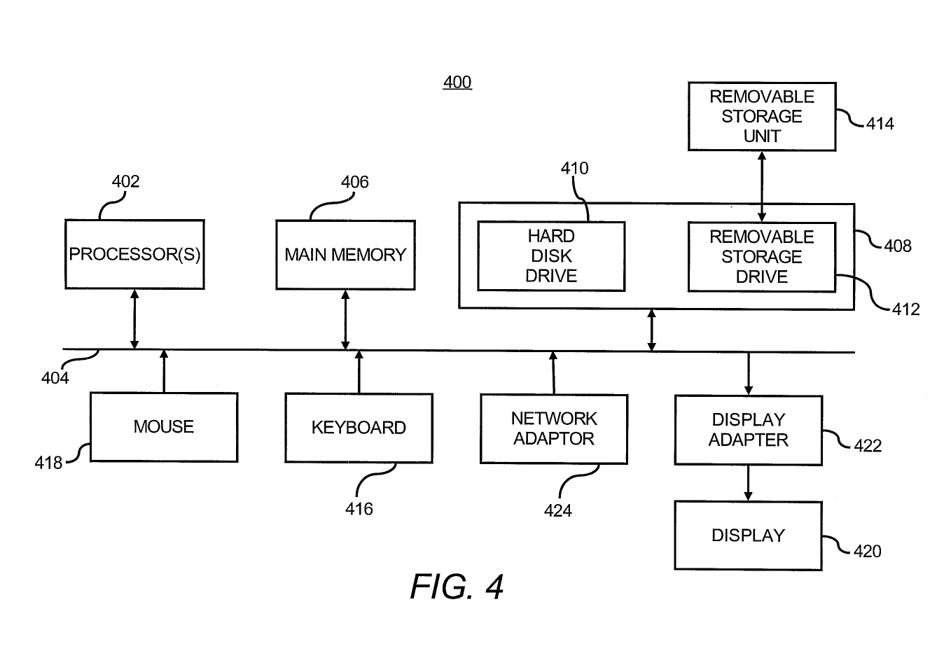

Turning now to FIG. 4, there is shown a block diagram of a computing apparatus 400 configured to implement or execute the reliability evaluator 102 depicted in FIG. 1, according to an example. In this respect, the computing apparatus 400 may be used as a platform for executing one or more of the functions described hereinabove with respect to the reliability evaluator 102.

The computing apparatus 400 includes a processor 402 that may implement or execute some or all of the steps described in the methods 200 and 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods 200 and 300 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method of managing a structure having an infrastructure system, said method comprising:
identifying a plurality of candidate components configured to provide redundancy to the infrastructure system, such that, a reliability level of the structure is increased through inclusion of the plurality of candidate components in the infrastructure system;
evaluating reliability levels of the structure with a plurality of different combinations of candidate components; and
managing the structure based upon the evaluated reliability levels.

2. The method according to claim 1, wherein evaluating reliability levels further comprises evaluating whether the reliability levels of the structure with the different combinations of candidate components meets a predefined reliability level, and wherein managing the structure further comprises outputting whether the different combinations of candidate components meets the predefined reliability level.

3. The method according to claim 2, further comprising:
determining a metric associated with at least one of installing and operating the different combinations of candidate components;
identifying a combination of candidate components that meets the predefined reliability level and is associated with relatively lower metric levels; and
wherein managing the structure further comprises outputting the identified combination of candidate components.

4. The method according to claim 1, further comprising:
identifying parameters related to the structure and to the infrastructure system;
selecting a plurality of components for use in the structure and the infrastructure system configured to meet the identified parameters;
obtaining reliability data of the plurality of components; and
wherein evaluating reliability levels of the structure further comprises evaluating the reliability levels based upon the reliability data of the plurality of components.

5. The method according to claim 4, wherein evaluating reliability levels of the structure further comprises evaluating a reliability level of the structure with one candidate component removed from the infrastructure system, said method further comprising:
determining whether the reliability level with the one candidate component removed meets a predefined reliability level; and
wherein managing the structure further comprises outputting the determination of whether the reliability level with one less candidate component meets the predefined reliability level.

6. The method according to claim 5, further comprising:
in response to the reliability level with the one candidate component removed meeting the predefined reliability level, determining whether another candidate component is removable;
selecting another candidate component to remove in response to a determination that the another candidate component is available for removal;
evaluating a reliability level of the structure with the another candidate component removed;
determining whether the reliability level with the another candidate component removed meets a predefined reliability level; and
wherein managing the structure further comprises outputting the determination of whether the reliability level with the another candidate component meets the predefined reliability level.

7. The method according to claim 6, further comprising:
in response to a determination that another candidate component is not available for removal, outputting a result of the evaluation with the one candidate component removed from the infrastructure system.

8. The method according to claim 5, further comprising:
in response to the reliability level with the one candidate component removed failing to meet the predefined reliability level, re-inserting the removed candidate component and determining whether a different candidate component is available for removal;
selecting a different candidate component to remove in response to a to determination that a different candidate component is available for removal;
evaluating a reliability level of the structure with the different candidate component removed;
determining whether the reliability level with the different candidate component removed meets a predefined reliability level; and
outputting the determination of whether the reliability level with the one different candidate component removed meets the predefined reliability level;
in response to a determination that a different candidate component is not available for removal, re-selecting a plurality of components for use in the structure and the infrastructure system;
obtaining reliability data of the plurality of components;
wherein evaluating reliability levels of the structure further comprises evaluating the reliability levels based upon the reliability data of the re-selected plurality of components; and
outputting a result of the evaluation with the re-selected plurality of components.

9. The method according to claim 5, further comprising
evaluating a break even point between cost and reliability of the plurality of components in the infrastructure system by comparing degradation of reliability and availability of the plurality of components with at least one of depreciation and amortization costs associated with the plurality of components.

10. The method according to claim 1, wherein managing the structure further comprises synthesizing the structure to have a plurality of zones, wherein at least two of the zones include respective infrastructure systems having different reliability levels.

11. A computer-implemented tool for managing a structure having an infrastructure system, said computer-implemented tool comprising:
a candidate component identification module configured to identify a plurality of candidate components configured to provide redundancy to the infrastructure system, such that, a reliability level of the structure is increased through inclusion of the plurality of candidate components in the infrastructure system;
a reliability level evaluation module configured to evaluate reliability levels of the structure with a plurality of different combinations of candidate components; and
an output module configured to output the reliability levels with the different combinations of candidate components.

12. The computer-implemented tool according to claim 11, further comprising:
an input module configured to communicate with one or more inputs, wherein the input module is further configured to identify parameters related to the structure and to the infrastructure system based upon data received from the one or more inputs;
a metric determination module configured to determine metric levels associated with at least one of installing and operating the different combinations of candidate components, wherein the reliability level evaluation module is further configured to identify a combination of candidate components that meets the predefined reliability level and is associated with relatively lower metric levels; and
wherein the output module is further configured to output the identified combination of candidate components.

13. The computer-implemented tool according to claim 11, further comprising:
a candidate component removal module configured to select one or more candidate components to remove from the infrastructure system;
wherein the reliability level evaluation module is further configured to evaluate a reliability level of the structure with the one or more candidate components removed from the infrastructure system and to determine whether the reliability level meets a predefined reliability level; and
wherein the output module is further configured to output the determination of whether the reliability level meets the predefined reliability level.

14. A computer readable storage medium on which is embedded one or more computer programs, said one or more computer programs implementing a method of evaluating reliability of an infrastructure system in a structure, said one or more computer programs comprising a set of instructions for:
identifying a plurality of candidate components configured to provide redundancy to the infrastructure system, such that, a reliability level of the structure is increased through inclusion of the plurality of candidate components in the infrastructure system;
evaluating reliability levels of the structure with a plurality of different combinations of candidate components; and
outputting the reliability levels with the different combinations of candidate components.

15. The computer readable storage medium according to claim 14, said one or more computer programs further comprising a set of instructions for:
identifying parameters related to the structure and to the infrastructure system;
selecting a plurality of components for use in the structure and the infrastructure system configured to meet the identified parameters;
obtaining reliability data of the plurality of components; and
wherein evaluating reliability levels of the structure further comprises evaluating the reliability levels based upon the reliability data of the plurality of components.
